(19) United States
(12) Patent Application Publication
(10) Pub. No.: US 2008/0154925 A1
(43) Pub. Date: Jun. 26, 2008

(54) SELECT/REFRESH METHOD AND APPARATUS

(75) Inventor: Ellen K. Richardson, Edwardsville, IL (US)

Correspondence Address: Michael R. Henson & Associates, LLC, 5613 DTC Parkway, Suite 240, Greenwood Village, CO, 80111, US

(73) Assignee: Mindworks, Inc., Broomfield, CO (US)

(21) Appl. No.: 11/959,036

(22) Filed: Dec. 18, 2007

Related U.S. Application Data
(63) Continuation of application No. 10/688,311, filed on Oct. 16, 2003, now abandoned.

(51) Int. Cl. G06F 17/30

(52) U.S. Cl. 707/100; 707/E17.044

(57) ABSTRACT

Provided is a method for extracting data of interest from a source and dynamically populating a target with the data of interest. The method includes providing a source database, a target database, and a data dictionary. User defined criteria is received that corresponds to the data of interest that is to be selected in the source and refreshed in the target. A linking process is initiated to interrogate the data dictionary to identify relationships between tables of interest in the source database and their associated key fields, and logically group the tables of interest. The method also includes dynamically building and executing an associated program with respect to each of the logical groups, which is operative to extract a corresponding sub-set of the data of interest from the source and thereafter load the subset of data in to the target, thereby populating the target with the data of interest.

### CROSS-REFERENCE TO RELATED APPLICATION

The present application is a continuation of U.S. application Ser. No. 10/688,311 filed on Oct. 16, 2003 and entitled SELECT/REFRESH METHOD AND APPARATUS (now pending), the disclosure of which is incorporated by reference in its entirety.

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND

The present invention generally relates to a source and target, and more particularly to a source and target that allow the selective refresh of data between the source and the target, and to the insertion of selected data from a source data base into a target data base.

For example, in a manufacturing environment, the source data base contains data on all raw materials used to make a particular product. Each of these raw materials is given a material number and that material number will in turn be associated to other pieces of data relevant to the manufacturing process (i.e. data pertinent to raw materials inventory, production orders, work in process, finished goods inventory, sales orders for the product, shipping and invoicing). The invention allows a user to transport all or part of this data to a different system for development, testing or training.

For example, in a system where manufacturing data is collected over a period of years, e.g., seven years in a manufacturing environment, a user might be interested in finding information about materials used to make shoes or a piece of machinery. The material would be related to a material number, and the material number can have data that relates to the purchase or sale of the material. The material number will be on many documents in the production system, such as sales documents, purchase order documents, production order documents, and other database documents. The user might want to bring all of this data or part of the data to a different system for testing, analysis for resource planning, accounting, finance or any other manufacturing related function. As another example, the selection could be done for a fiscal year. The database information could include purchase centers, profit centers, work centers, cost elements and so on. In commercial database systems, such as an SAP system, a client copy, can take from four hours to two weeks to bring down this data. If such a client copy is executed in a large system, that requires shutdown and disablement of the system, because the database is being transferred. Others have transferred “units of work”, an SAP concept, which takes a considerable amount of time as well, because prior solutions require all transactions to be transferred.

Prior art systems have mechanisms that transfer valid data from production systems down to test and development systems but these alternatives require either (i) making a copy of the entire database over to the target system, a process that requires bringing down the source system for a period of hours or days, or (ii) sending a smaller subset of data through an “application program interface” that verifies the completeness of the data selected but greatly increases the processing time.

Thus, prior art systems have mechanisms that transfer valid data from production systems down to test and development systems. Currently, systems such as the database systems from an SAP system have only the single mechanism to do this, which is taking all of production data and transferring it to a test or development environment. Many of these databases are large or can be considered huge, and the transfer of an entire database could require, depending on its size, from four hours to two weeks. The problem is exacerbated by the fact that data could go back many, many years, increasing the size of the database, and users may ideally require multiple updates. Prior systems have struggled with this because of the massive amount of data and time it requires to transfer this data. The lack of an update forces systems that are tracking the status of the database to lag. Further, typically, the production environment needs to be halted to allow the transfer of the data, thus costing the operators of the database downtime, which can be considerable in a large production environment.

Thus, it is desirable to be able to only bring in data that is of interest to a party querying the production database.

Thus, a need exists for a system that reduces the amount of time it takes to capture, extract and update data on a source and target without requiring transfer of the entire database.

### SUMMARY OF THE INVENTION

A computerized method is provided for extracting data of interest from a source and dynamically populating a target with the data of interest. According to the method, both source and target databases are provided each having a plurality of source and target tables, respectively. The source tables contain data items and each table includes at least one key field. The target database has a table structure which is similar to that of the source. A data dictionary is also provided which also identifies relationships between the source tables and their associated key fields. User-defined criteria is received corresponding to the data of interest to be selected in the source and refreshed in the target. A linking process is then initiated to interrogate the data dictionary and identify, based on the user-defined criteria, relevant relationships between tables of interest within the source database and their associated key fields, and to group tables of interest into at least one logical group. An associated program is dynamically built and executed with respect to each logical group. Each program operates to extract a corresponding sub-set of data of interest from the source and thereafter load the sub-set into the target, thus populating the target database with the data of interest.

Another embodiment of the computerized methods avoids the linking process and, instead, identifies a sub-set of tables from the source tables based on pre-defined criteria to be transferred to the target. The target database is then populated with the data of interest by programs which are dynamically built and executed to transfer the data within a respective one of the tables. In this embodiment, of course, the pre-defined criteria may additionally incorporate user-defined criteria.

The various computerized method embodiments may be implemented in an enterprise resource planning (ERP) environment using an SAP database for the source and target. Preferably, the source is a production level database and the target is not. The described methods avoid transferring all or substantially all data items within the source database to the target database, thereby reducing the amount of time in which the data of interest is extracted from the source and populated into the target as compared to prior approaches. Preferably also, the tables of interest within the source are grouped into a plurality of logical groups whereby a plurality of programs are executed for creating dynamic programs, each operative to send a respective one of the tables of interest to the target and load its associated sub-set of data of interest into the target. Moreover, the linking process is further operative to check each table of interest against the data dictionary to identify both direct and indirect relationships amongst the tables in the logical groups.

Also described is a select and refresh system comprising a source database, a target database, and a data dictionary, each as discussed above. The interfaces are provided for receiving the user-defined criteria. Also provided is a link to the database transfer system which is operative to interrogate the data dictionary, as discussed above, and dynamically execute an associated program with respect to each logical group, also as discussed above, to ultimately populate the target data with the data of interest.

These and other objects will become readily appreciated and understood from a consideration of the following detailed description of the exemplary embodiments when taken together with the accompanying drawings, in which:

### DESCRIPTION OF THE DRAWINGS

The illustrative embodiment may best be described by reference to the accompanying drawings where:

FIG. 1 shows a hardware diagram of a source and a target according to the preferred teachings of the present invention.

FIG. 2 shows a hardware diagram of multiple sources and targets according to the preferred teachings of the present invention.

FIG. 3 shows a schematic diagram of a select/refresh process according to the preferred teachings of the present invention.

FIG. 4 shows a schematic diagram of a portion of the linking process according to the preferred teachings of the present invention.

FIG. 5 shows a schematic diagram of a portion of the linking process to generate a ZSEL table according to the preferred teachings of the present invention.

FIG. 6 shows a schematic diagram of a portion of the linking process to generate ZSEL linked data according to the preferred teachings of the invention.

FIG. 7 shows a schematic diagram of a portion of the linking process to generate the ZSEL SEND TABLES according to the preferred teachings of the present invention.

FIG. 8 shows a schematic diagram of a portion of the linking process of the invention showing the generation of the ZSEL filter table.

FIG. 9 shows a schematic diagram showing an example of a portion of the select process based on a selection of a material master header according to the preferred teachings of the present invention.

FIG. 10 shows a schematic diagram of a portion of the select process option choice and send process according to the preferred teachings of the present invention.

FIG. 11 shows a schematic diagram of a portion of the select process to generate key field values according to the preferred teachings of the present invention.

FIG. 12 shows a schematic diagram of the refresh process according to the preferred teachings of the present invention.

FIG. 13 shows a schematic diagram of the program generation operations of the refresh process shown in FIG. 12, according to the preferred teachings of the present invention.

FIG. 14 shows a schematic diagram of processing nonkey fields and associated data for refresh processing according to the preferred teachings of the present invention.

FIG. 15 shows a schematic diagram of the target receive process according to the preferred teachings of the present invention.

All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific sizes, speeds, capacities, and similar requirements will likewise be within the skill of the art after the following description has been read and understood.

Where used in the various Figures of the drawings, the same numerals designate the same or similar parts. Furthermore, when the terms “first”, “second”, “inside”, “outside”, “upper”, “lower”, “height”, “width”, “length”, “end”, “side”, and similar terms are used herein, it should be understood that these terms have reference only to the structure shown in the drawings as it would appear to a person viewing the drawings and are utilized only to facilitate describing the illustrative embodiment.

### DESCRIPTION OF THE PREFERRED EMBODIMENT

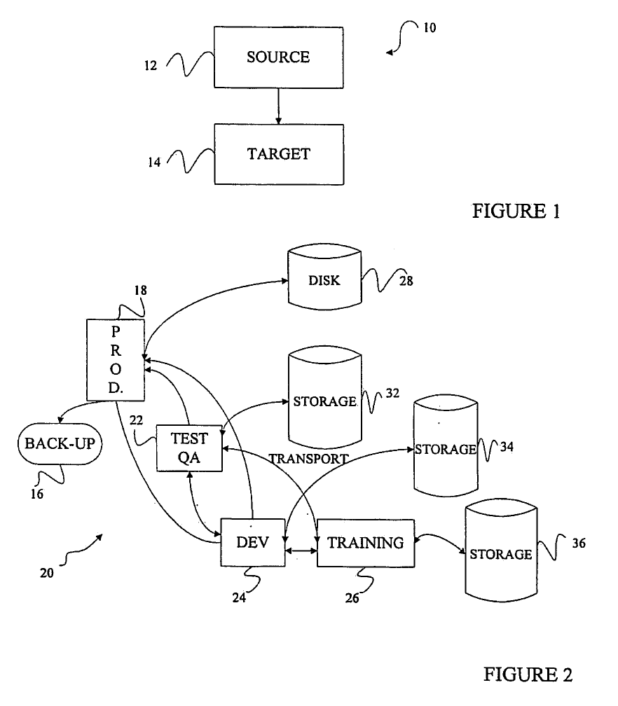

Refer now to FIG. 1 which shows a hardware diagram of a source 12 and a target 14 in a system that, according to the preferred teachings of the present invention, is able to allow a selection of a data to extract a user defined subset of database information from the source 12 and refresh, by transport, the information to the target 14. The user of the system identifies what materials they want refreshed, for example, like 3-4 materials. From that piece of information, the source 12 and target 14 cooperate to process and bring down everything related to the documents that have those materials as a line item. Among the thousands of tables in a database, such as SAP, the source 12 traverses different tables and threads down through all of these tables using a key that either is driven by a material number or driven by a document that had the material number as a line item. The source 12 then picks off different data from those documents to pick up other data. The source 12 follows the data's tree structure and starts off with the material and examines thousands of tables from that information. The source 12 and target 14 then cooperate to perform a select refresh, as described herein.

The user of the system defines the parameters of the data items the user would like transported from the source 12 to the target 14. From these parameters, the present invention operates to assemble all data present on the source 12 database related to the selected data items pursuant to the identified key field within each applicable data table.

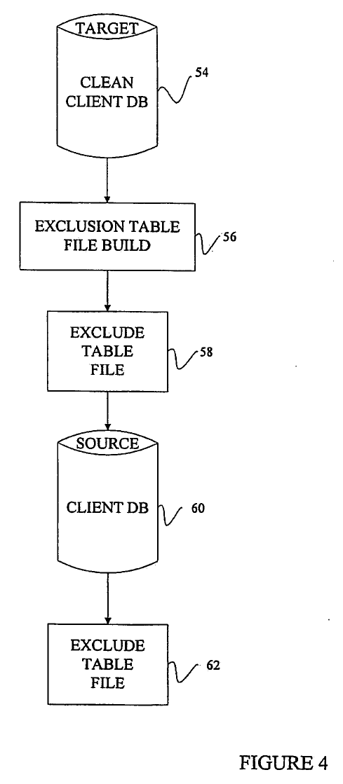

Suitable provisions are provided in the source 12 and target 14 to execute a database program on the source 12 and the target 14 that contains user data such as used in enterprise resource planning environments that can selectively refresh target data. According to the preferred teachings of the present invention, the database could be a database available from SAP of Germany that has multiple levels of architecture. The first level is a development level, the second level is a testing level and the third level is a production level. In one embodiment, the production level is running in the source 12, and the test and development levels are running in the target 14. Those skilled in the art will recognize that, depending on the application, the different levels could be running on either the source 12 or the target 14. Those skilled in the art will recognize that the system 10 could be implemented as a server system, quad processor, multiple boxes, CPU and disc array, workstations or remote computers running through a bus, local area network, wide area network, intranet or the Internet. The target 14 running the extraction process of the invention described herein is able to transfer selected data from the source 12 and avoids transferring all or substantially the entire source database 60, shown in FIG. 4.

Refer now to FIG. 2, which shows a hardware diagram showing an alternate system 20 according to the preferred teachings of the present invention having a production system 18 connected to storage 28 and backup system 16 for backup of data as conventionally known. The production system 18 is also connected to a test system 22, and the production system 18 is also connected to a development system 24. The test system 22 is connected to storage 32. The development system 24 is connected to storage 34. A training system 26 is connected to the test system 22 and is connected to storage 36. Those skilled in the art will recognize that the storage, such as storage 36, 34, 32, 28 may be a hard disk drive, Sandisk, RAID or other storage system. The production system 18, the test system 22, the development system 24 and the training system 26 can be any number of computer systems including mainframes, servers, workstations or personal computers running a database. The database could be an enterprise level database such as one from SAP. According to the preferred teachings of the present invention, the SAP database is used to implement the extract system using the SAP programming language ABAP in a process for selecting and refreshing data. Those skilled in the art will recognize that other database systems and programming languages may be used without deviating from the spirit and scope of the invention.

Methods according to the preferred teachings of the present invention have been implemented as an ABAP program in the SAP database programming and data environment.

Example identification for linking 46 programs according to the preferred teaching of the present inventions are incorporated by reference hereto as a computer program listing appendix on CD Rom files which were previously submitted concurrently with the filing of parent application Ser. No. 10/688,311, on Oct. 16, 2003.

| | | | |
|---|---|---|---|
| 10/16/2003 | 10:58 a | 7,686 bytes | ZSELI_CHECK_CONFIG_TABLES.TXT |
| 10/16/2003 | 10:58 a | 2,806 bytes | ZSELI_EXCLUDED_TABLES.TXT |
| 10/16/2003 | 10:58 a | 37,155 bytes | ZSELI_TABLES_FORMS.TXT |
| 10/16/2003 | 10:58 a | 1,016 bytes | ZSELI_TABLES_MASTER.TXT |

Example target 14 functions programs according to the preferred teaching of the present inventions are incorporated by reference hereto as a computer program listing appendix on CD Rom files which were previously submitted concurrently with the filing of parent application Ser. No. 10/688,311, on Oct. 16, 2003.

| | | | |
|---|---|---|---|
| 10/16/2003 | 11:00 a | 1,302 bytes | LZSEL_TARGET$01.txt |
| 10/16/2003 | 11:00 a | 42,353 bytes | LZSEL_TARGETF01.txt |
| 10/16/2003 | 11:00 a | 1,009 bytes | LZSEL_TARGETTOP.txt |
| 10/16/2003 | 11:00 a | 5,473 bytes | LZSEL_TARGETU01.txt |
| 10/16/2003 | 11:00 a | 342 bytes | LZSEL_TARGETUXX.txt |
| 10/16/2003 | 11:00 a | 747 bytes | SAPLZSEL_TARGET.txt |

Example linking 46 programs according to the preferred teaching of the present inventions are incorporated by reference hereto as a computer program listing appendix on CD Rom files which were previously submitted concurrently with the filing of parent application Ser. No. 10/688,311, on Oct. 16, 2003.

| | | | |
|---|---|---|---|
| 10/16/2003 | 11:05 a | 1,231 bytes | ZSEL_CHECK_ONR00.TXT |
| 10/16/2003 | 11:05 a | 198,802 bytes | ZSELI_LINK_FORMS.TXT |
| 10/16/2003 | 11:05 a | 2,474 bytes | ZSELI_LINK_FILTER.TXT |
| 10/16/2003 | 11:05 a | 842 bytes | ZSELI_LINK_DATA.TXT |
| 10/16/2003 | 11:05 a | 901 bytes | ZSELIR_DOC_PROGRAMS.TXT |
| 10/16/2003 | 11:05 a | 1,693 bytes | ZSELIR_LINK_DATA.TXT |

Example mainscreen interface programs for target 14 for select operations 48 according to the preferred teaching of the present inventions are incorporated by reference hereto as a computer program listing appendix on CD Rom files which were previously submitted concurrently with the filing of parent application Ser. No. 10/688,311, on Oct. 16, 2003.

10/16/2003 11:05a 24,000 bytes ZSEL_OUT.TXT

Example mainscreen interface for source 12 for select operations 48 according to the preferred teaching of the present inventions are incorporated by reference hereto as a computer program listing appendix on CD Rom files which were previously submitted concurrently with the filing of parent application Ser. No. 10/688,311, on Oct. 16, 2003.

| | | | |
|---|---|---|---|
| 10/16/2003 | 11:06 a | 22,890 bytes | ZSEL_IN.TXT |
| 10/16/2003 | 11:06 a | 21,262 bytes | ZSEL_MARA_REFRESH.TXT |
| 10/16/2003 | 11:06 a | 5,226 bytes | ZSEL_SALES_REFRESH.TXT |

Example send process programs for refresh 50 according to the preferred teaching of the present inventions are incorporated by reference hereto as a computer program listing appendix on CD Rom files which were previously submitted concurrently with the filing of parent application Ser. No. 10/688,311, on Oct. 16, 2003.

| | | | | |
|---|---|---|---|---|
| 10/16/2003 | 11:06 a | 7,280 | bytes | ZSEL_ALL_DATA_DOCS.TXT |
| 10/16/2003 | 11:06 a | 504 | bytes | ZSEL_COMMON.TXT |
| 10/16/2003 | 11:06 a | 10,443 | bytes | ZSEL_COMMON_ALTERNATIVES.TXT |
| 10/16/2003 | 11:06 a | 33 | bytes | ZSEL_COMMON_DELETE.TXT |
| 10/16/2003 | 11:06 a | 238 | bytes | ZSEL_COMMON_HR.TXT |
| 10/16/2003 | 11:06 a | 210,720 | bytes | ZSEL_COMMON_LINK.TXT |
| 10/16/2003 | 11:06 a | 34,943 | bytes | ZSEL_COMMON_ONLINE.TXT |
| 10/16/2003 | 11:06 a | 493 | bytes | ZSEL_COMMON_OPTIONS.TXT |
| 10/16/2003 | 11:06 a | 2,899 | bytes | ZSEL_COMMON_PROGRAM_VERSIONS.TXT |
| 10/16/2003 | 11:06 a | 109,525 | bytes | ZSEL_COMMON_SEND.TXT |
| 10/16/2003 | 11:06 a | 56,673 | bytes | ZSEL_COMMON_TOP.TXT |
| 10/16/2003 | 11:06 a | 6,607 | bytes | SEL_FI_DOCS.TXT |
| 10/16/2003 | 11:06 a | 42,292 | bytes | ZSEL_SALES_DOCS.TXT |
| 10/16/2003 | 11:06 a | 1,920 | bytes | ZSELA_KEKO_KEPH.TXT |
| 10/16/2003 | 11:06 a | 2,247 | bytes | ZSELA_VAKPA.TXT |

Example utility programs for select refresh operations 21 according to the preferred teaching of the present inventions are incorporated by reference hereto as a computer program listing appendix on CD Rom files which were previously submitted concurrently with the filing of parent application Ser. No. 10/688,311, on Oct. 16, 2003.

10/16/2003 11:07a 7,745 bytes ZSELU_NRIV.TXT Those skilled in the art will recognize that various programs from one group may be used by other groups and vice versa due to the inter-related nature of the programming environment. These program groupings are not to be interpreted to be restrictive but rather illustrative of the preferred teachings of the present invention.

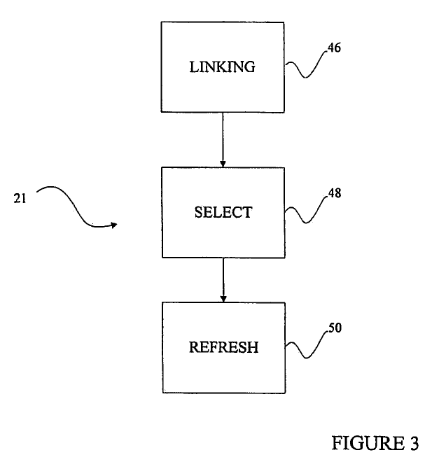

Refer now to FIG. 3, which shows the select and refresh process 21 according to the preferred teachings of the present invention. The select and refresh process 21 has three phases, a linking process 46 that cooperates to prepare for a select process 48 and a refresh process 50. The output of the linking process 46 is sent to the select process 48. The output of the select process 48 is sent to the refresh process 50. While the linking process 46 can be run more than once for each environment the linking process 46 needs to be run at least once after a change is made to the structure of the source database 60 and need not be run again until another change is made to the structure of the source database 60.

Refer now to FIG. 4, which shows methods to create an exclude table 62 from a target database 54 running on the target 14. Suitable provisions are provided to establish a database relationship between elements of the source database 60 so that a user can select a data item for refresh and the database relationships established during the linking process 46 is used to refresh only those database items that have a database relationship with the selected data item. The methods start with the target database 54 that contains only configuration tables (a “clean client”) which is then read to generate an exclude table file 58 in a build phase 56. The build phase 56 generates the exclude table file 58 by checking each table for static data such as configuration data. If a configuration table has data, the name of the table is put into the exclude table file 58. The exclude table file 58 then populates the exclude table 62 in the source database 60 on the source 12. Thus, the exclude table 62 contains table names of static configuration tables in the target database 54. The exclude table file 58 is loaded into the source database 60 and creates and populates an exclude table 62 on the source 12.

The target database 54, also called a clean client, does not contain any data other than configuration data or other static data. The tables that have data in them from the clean database 54 are processed in the build phase 56 that determines if any tables have configuration data. If a table has configuration data, the name of the table is put into the exclude table file 58. The exclude table file 58 then populates the exclude table 62 in the source database 60 on the source 12. Thus, the exclude table 62 contains table names of static data tables, such as configuration tables, in the target database 54. The objective is to determine automatically, without specific knowledge of the contents of the target database 54, the tables that can be safely ignored during a select/refresh operation.

The build phase 56 takes a snapshot of what tables are populated and therefore also knows what tables aren't populated. For example, from over 10,000 tables in the SAP database, 1,000 tables may be in the exclude table file 58. This avoids the necessity of distinguishing tables by table name.

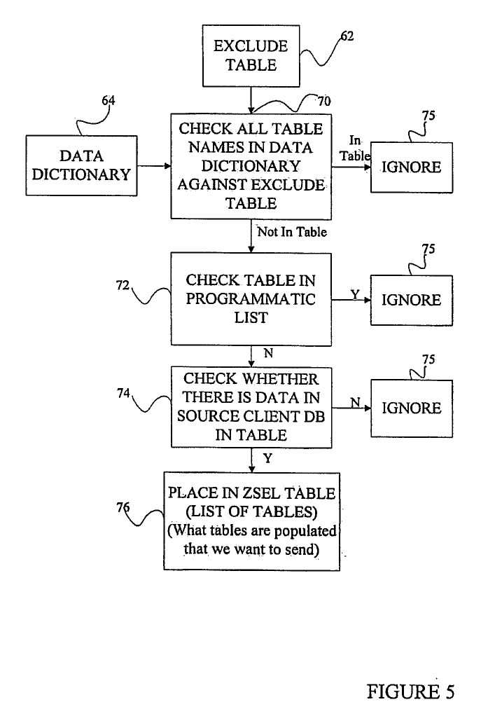

Refer now to FIG. 5, which shows the exclude table 62 being processed to generate a ZSEL table 76. The exclude table 62 is processed to check all table names in a data dictionary 64 against the table names in the exclude table 62. The data dictionary 64 is an element of the target 14 and source 12 that lists every table in both the target database 54 and the source database 60. The process of checking operation 70 checks every table in the data dictionary 64 against the exclude table 62. The results of the checking operation 70 are sent to a programmatic list check operation 72 where tables are eliminated using pre-defined criteria. The programmatic list check operation 72 allows a table that is known to never be the subject of a select/refresh to be eliminated from consideration. For example, the CKHS table is a table of result of a cost run for all materials etc. The results of the cost run would be useless in the target 14 because the results would be for the source 12 and not represent the state of the target 14. If the table names are in exclude table 62, the tables are ignored in operation 75, or if they have been programmatically eliminated in the programmatic list check operation 72, they are also ignored in operation 75. In data checking operation 74, a check is made to determine if there is data in any of the tables remaining after the programmatic list check operation 72 in the client database running on the source 12, then that table name is placed in the ZSEL table 76. If there is no data in a table from the data dictionary 64 that made it through the programmatic list check operation 72, then the table is ignored in operation 75. Thus, only tables that have data in them pass the programmatic list check operation 72 and are not in the exclude table 62 will be listed in the ZSEL table 76. ZSEL table 76 thus represents only tables that would be the subject of a select/refresh. This mechanism saves space and saves time during a select/refresh operation.

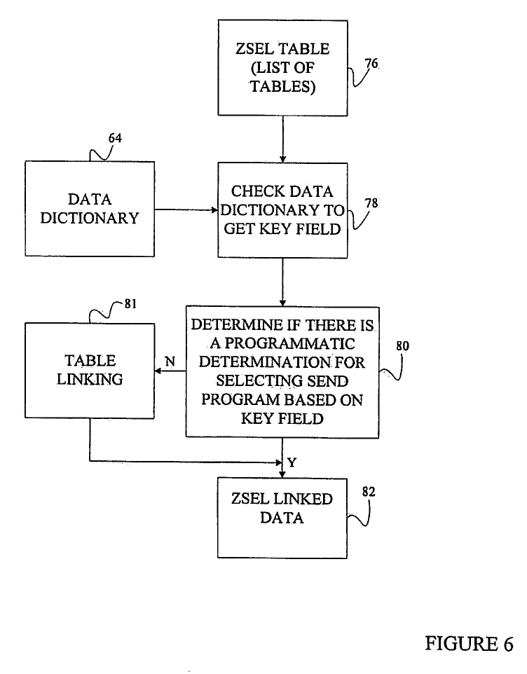

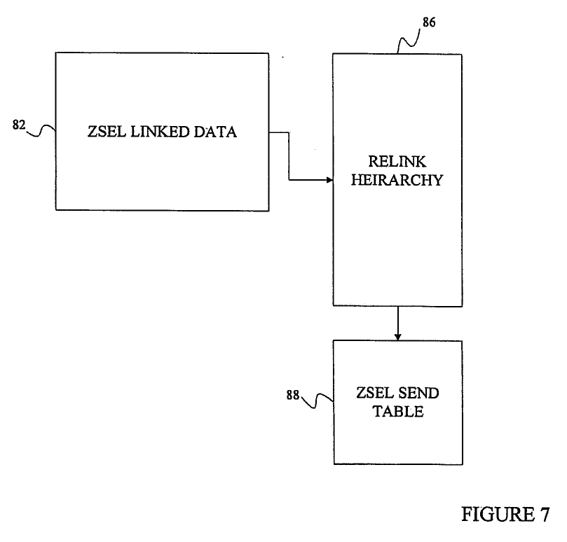

Refer now to FIG. 6, which shows methods to generate a ZSEL link database 82 from the ZSEL table 76. The ZSEL table 76 is first checked in check operation 78 against the data dictionary 64 to obtain its key field or fields. The key field is a well-known concept on the database where the key field is used for sorting, indexing and for other well-known database operations. The check operation 78 generates a list of key fields for each table in the ZSEL table 76. This list is stored in a ZSEL link data table 82, which relates the table name, what key field it is linked by, and the name of a send program that will accomplish the send function in later processes. Multiple key fields generate multiple entries. The entire ZSEL table 76 is processed by the check operation 78 and by the identification operation 80 and the results are listed in the ZSEL link data table 82. The identification operation 80 proceeds by identifying key fields that are programmatically linked to each table that is to be refreshed in the target 14. If the key field is so linked, it is included in the ZSEL link data table. If it is not so identified, it is reviewed and linked on a table by table basis. Those skilled in the art will recognize that the same table can be linked by more than one key field and thus could be the subject of more than one transfer program, in which case the present invention programmatically determines which transfer program will be used as described herein and with reference to FIG. 7. Those tables that are not identified in identification operation 80 can be identified by a table linking operation using either user input or by a manual process of selection in selection in a table by table linking operation 81 that links appropriate send programs and these are stored in ZSEL LINKED DATA 82, as well.

Refer now to FIG. 7, which shows methods of the invention to remove redundant transfer programs. The ZSEL link data table 82 is sent to a programmatic re-link hierarchical determinator 86, which programmatically, based on preferences such as table exclusivity, timing, or size, determines what program set a table will be transferred by and this result is referenced in the linked data table 82 and is noted in the ZSEL SEND TABLES 88. This determination is based on criteria such as either a material number, program or a sales number program. After this determination, the specific send program that will be used to accomplish the refresh and transfer the data to the target is referred to in the linked data table 82 and is noted in the ZSEL SEND TABLES 88. The re-link hierarchical determinator 86 allows the control and elimination of redundant transfers by a programmatic determination. For example, a table could have both sales order and material number in its keys. Preferably, information is to be sent by the selection of sales order number. When the user selects by select data, the user will only select certain sales orders relating to material in the database as of a certain date, or date range. Otherwise, if the select/refresh program 21 selects that table by materials, the program could be sending data that is seven years old, if the material has been around that long. So what the program preferredly asks for is a date for how far back a user wants to go on sales orders with that material as one of the database entries and so sales order becomes a more filtered way to get to data then material does. By starting with material, the sales orders that were created on or after a certain date can be transferred, cutting down the amount of data being sent. The output of the re-link hierarchical determinator 86 is a ZSEL SEND TABLES 88, which lists the table name, the key field and the applicable transfer program that was selected programmatically by the re-link hierarchical determinator 86. Thus a relation has been established between a table, a key field and a transfer program. The select process 48 and refresh process 50 will exploit these relationships.

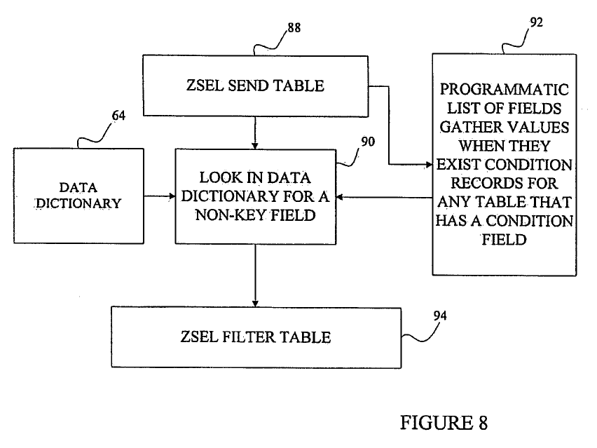

Refer now to FIG. 8, which show methods of generating a ZSEL filter table 94 from the ZSEL SEND TABLES 88. The ZSEL SEND TABLES 88 is checked against a data dictionary in data dictionary check operation 90 for a non-key field. If the ZSEL SEND TABLES 88 has a non-key field, a programmatic list of fields is checked in programmatic check 92 to force the gathering of values for certain pre-defined records, such as condition records. This insures that any non-key fields within a table also trigger the sending of data during a select refresh. This further assures that any data that is of interest as determined by the programmatic list of fields that are not in key fields are also included in a refresh operation. The output of the data dictionary check operation 90 is a ZSEL filter table 94, which associates a table name with a non-key field name and a condition. The ZSEL filter table 94 now can be used with the ZSEL SEND TABLES 88 to refresh data associated with a field, even if it is not a key field.

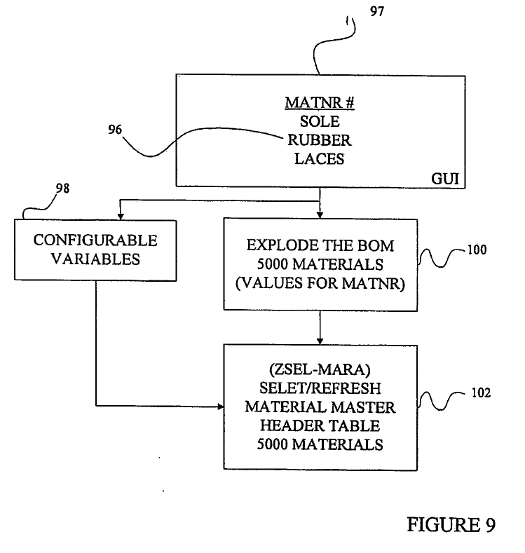

Refer now to FIG. 9, which show methods of selecting a data item to be refreshed from the source 12 to the target 14. The user or selector interfaces with a graphical user interface or command line interface 96. The user selects a field such as material number 97 to be sent. The process of the invention then “explodes the BOM” operation 100, BOM is short for Bill Of Materials, where the material number 97 is used to flatten the source database 60 and every material associated with that number is listed in a flat file. These methods of “exploding the BOM” operation 100 is well known database operation that allows all related hierarchical information related to a data element to be extracted from a database. Also, another operation known as configurable variables 98 is executed to also detect and determine any associated values to the selected material number 97 selected by the user, the configurable variables 98 are included along with the output of the BOM operation 100. The output of the configuration variables operation 98 and the exploding of the BOM operation 100 can be compared to check for consistency, for tables or records possibly missed, and/or can be combined. The output of the flattening of the structure is data, that in one embodiment according to the preferred teachings of the invention is called a ZSEL MARA list 102, which creates a material master header table 102 of all material numbers 97 associated with the one selected by the user.

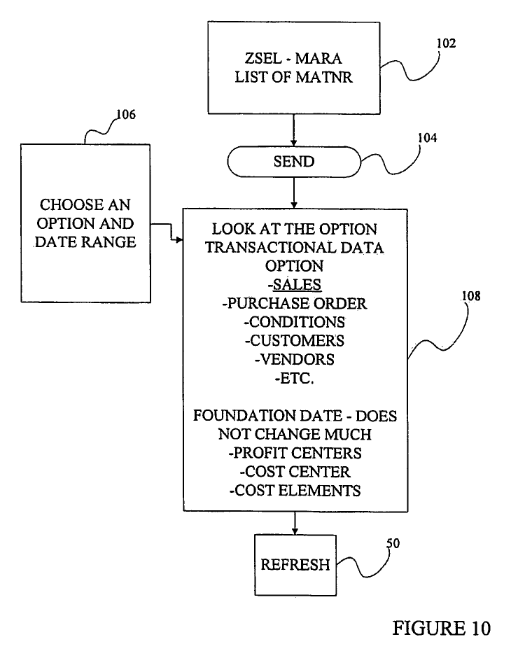

Refer now to FIG. 10, which shows methods of the invention to process the ZSEL MARA list 102 of material numbers and perform the refresh operation 50 in the target 14. By using either a pull down list or graphical user interface, GUI interface, the user chooses a number of options 106, such as the interfaces available in the SAP systems. The options 106 could in one example embodiment according to the preferred teachings of the present invention include the type of transfer data and a date range. Those skilled in the art will recognize that any options 106, such as option information or selection criteria may be used, for example, for use with a material list, the options could include transactional data such as sales data, purchase order numbers, conditions, customers, vendors, etc., or foundation data that doesn't change as frequently such as profit centers, cost centers or cost elements. The options 106 can be any desired option and are not limited to the ones shown. After all the options are chosen and the user indicates a send 104, the process uses the additional filtering criteria in option application operation 108 that is used to implement the refresh operation 50.

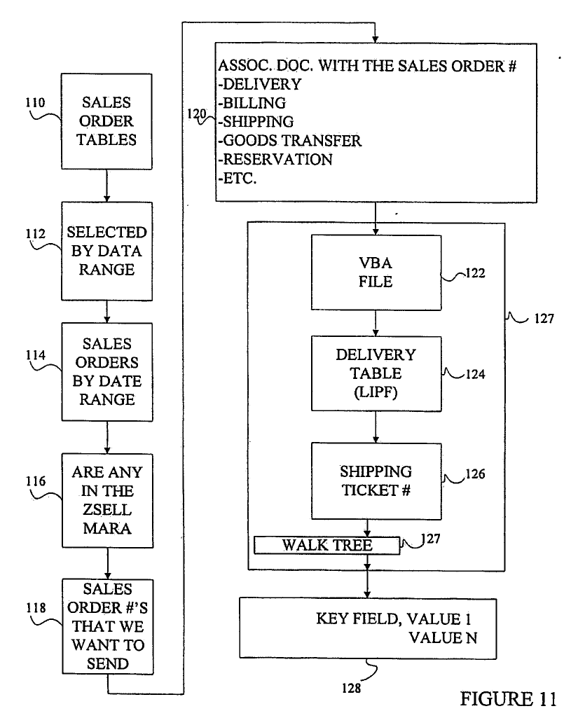

Refer now to FIG. 11, which shows a method of the invention to implement the send 104 and implements the option application operation 108. The subject database table 110 that according to the preferred teachings of the present invention is a table such as a sales order table or a plurality of sales order tables is queried. The user, by clicking the send button, initiates a program that looks at material number and the first program that will be run will be the send program associated with this key field. The send operation 104 accesses the subject database table 110, for example a sales order table, and determines what sales orders had the material numbers that have been selected and retrieves those sales order numbers. For example, there may be a million sales orders and only sales orders that were created a week ago are wanted which would result in only 200 sales order numbers. There can be more than one of these subject database tables 110 containing salient information. Those skilled in the art will recognize that the sales order table is used by way of example and not limitation and that any other database table can be used. The sales order tables are first filtered by the selected data range in date range check operations 112, selected by the user in select operation 106 and the records that meet the selected date range 114 are further processed to determine in operation 116 if these values are in the ZSEL MARA table 102. If values are in the ZSEL MARA table 102, these are the sales order numbers, stored in list 118, that are going to be sent and refreshed in the target 14. The order numbers, listed in list 118, are used by way of example and not limitation and other types of data can be selected and refreshed as desired by the user. In the database 22, other items 120 are also associated with the sales order numbers. In general, other items 120 that have been the subject of the select/refresh such as sales order numbers 110 also have associated items. These other items 120 will include delivery numbers, billing numbers, shipping numbers, good transfer numbers and reservation numbers, etc. The SAP database provides a facility, called a VBFA file 122, that contains a listing of associated numbers and the methods of the invention hierarchically queries the VBFA file to, for example, find a delivery file 124 that has a shipping ticket number 126, but those skilled in the art will recognize that any similar function may be used without deviating from the spirit and scope of the invention. In traversal operation 127, the VBFA file is traversed 127 and the tree structure for associated documents 120 is used to develop a programmatic list for key fields with associated values 128 based on sales order numbers that are to be sent. Thus, all the key field values 128 are known that need to be refreshed based on the user input 96.

For example, the select/update system 21 has linked all documents with the sales order, the delivery order number, and the shipping order. All this information has been obtained from the different documents that are all in the sales group. So the sales order will point to a delivery document. That delivery number allows the identification and transfer of tables that hold the delivery information as derived from the sales order. Likewise, that sales order may have been billed already. So there will be a billing document. So this triggers the sending of the billing documents, the tables that have the billing documents as the key, because that will match, and it is known what billing documents were sent out by those sales orders that were selected because of the material number.

For example, in a transfer with 200 sales order numbers where 50 tables are called out, 50 transfer programs will be created to implement the refresh.

One skilled in the art will recognize the significant improvement and reduction in time required to send refreshed data, because now instead of having to transport the entire database or entire portions of the database only, those specific key field values that are the subject of interest by the user need to be transferred, significantly reducing the amount of data needed to refresh the target 14. Those skilled in the art will also recognize that the linking process 46 enables efficient sending of the key field values, because the linking process 46 has already determined what program is needed to send those tables for the key fields.

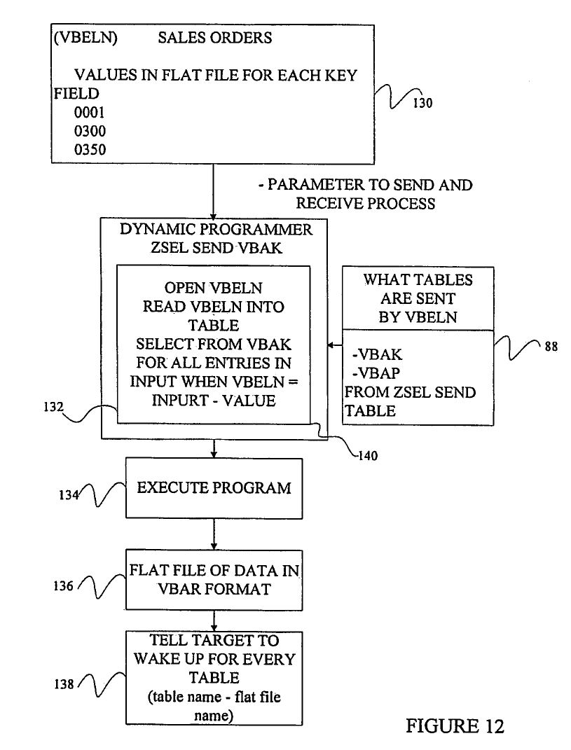

Refer now to FIG. 12, which shows methods of the invention to process a flat file of key field values and transfer and refresh key field values in the target 14. The values determined to be the subject of transfer are written to a flat file 130 that relates those values by the file name of the file 130 to the key fields. The ZSEL table 76 links the program and table name that sends that key field. A dynamic programmer 132, called the common send program because every program uses it, automatically generates a send program 140 for each table, for instance, with the VBELN key field, the dynamic programmer 132 will create the send program 140 that opens the first table called VBAK in the ZSEL table 76 and creates the send program 140 that transfers those values that equal the input value from the sales order flat file 130. Some examples of send programs, listed in ZSEL SEND TABLE 82, are SALESDOCS and MATNRDOCS. The dynamic programmer 132 is used by all the programs, for example, the sales order, purchase order, production orders, condition records, etc. The dynamic programmer 132 dynamically programs repeatedly for each element of the ZSEL table 76 that is indicated for the key field. The send program 140 is executed by execute operation 134 and the flat file 130 of data is created for that table. The process then “wakes up” the target 14 in wake operation 138 and notifies the target 14 that there is a program available to update a specific table in the target database 54. As indicated by ZSEL SEND TABLES 88, the next table to be sent will be VBAP and so on until all tables in ZSEL SEND TABLES 88 are sent for that key field, VBELN.

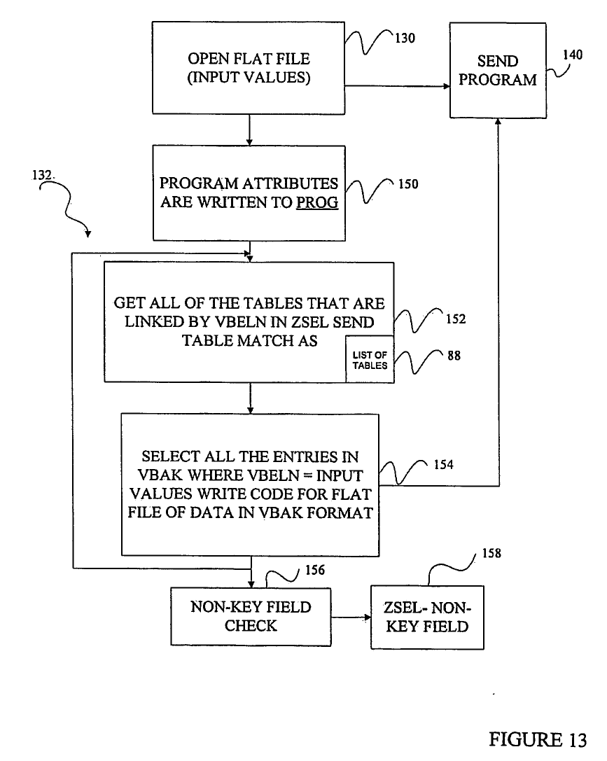

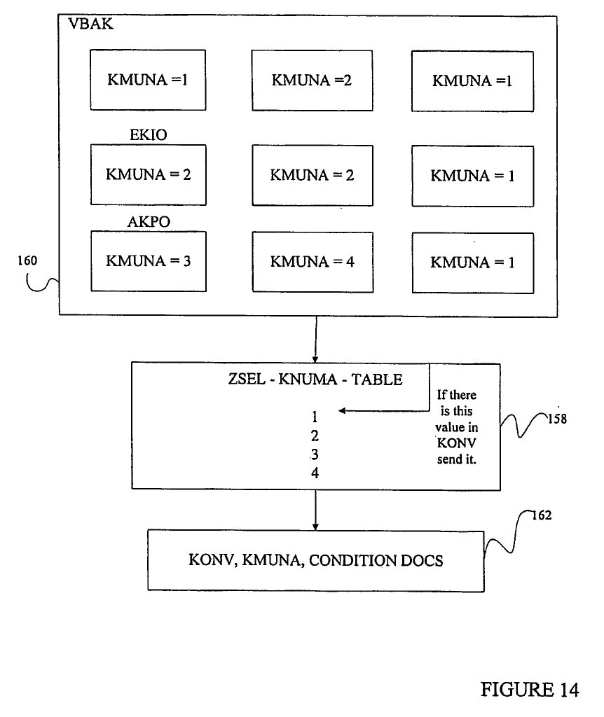

Refer now to FIG. 13, which shows methods of generating refresh code from the flat file 130. During program creation, the standard programming parameters, headers, variable declarations, and overhead code is first sent in preparation operation 150 to the send program 140 to be generated. This allows the send program 140 to properly execute in the execution environment. Those skilled in the art will recognize that the send program 140 could be a macro, a compiled program, interpreted program, inline or any other suitable program that can manipulate the databases that need to be refreshed. The table organization operation 152 then gets all of the tables that are linked by the key field from the list of tables from ZSEL SEND TABLE 88. The table organization operation 152 then drives a host of tables into the refresh coder operation 154 where the send program 140 receives the database manipulation statements for that particular table. When all tables for the key-field under consideration are processed, the non-key field check operation 156 is performed. The non-key field operation 156 generates a file of values 158 for non-key fields that will be processed when all key-fields are processed. The non-key field operation 156 is shown in more detail in FIG. 14. When the send program 140 contains all the code to refresh all the records indicated by the flat file 130, the send program 140 is executed 134, as shown in FIG. 13. Those skilled in the art will recognize that other well known finishing code can be inserted into the send program 140 depending on the programming and execution environment to ready the send program 140 for proper execution.

Refer now to FIG. 14, which show methods according to the preferred teachings of the present invention to process non-key fields. The processing of non-key fields is similar to the processing of key-fields except that the data for non-key fields, such as condition fields shown being processed in FIG. 8 to generate the ZSEL Filter Table 94, is collected as the key fields are being refreshed over multiple tables. For example, the collection operation 160 operates over three tables VBAK, EKIO, and AKPO. During the collection operation, the file of values 158 ZSEL_KNUMA_TABLE is being created that contains unique value of the KNUMA field. This table will then be used by the send program for the nonkey field send programs 162, in this example CONDITION DOCS, after all the key fields have been refreshed. The non-key field send programs 162 operate like the other key field send programs 140.

Those skilled in the art will recognize that the tables, key fields, non-key fields, program names, and environment names are by way of example and not limitation. The methods according to the preferred teachings of the invention can be applied to any tables, key fields, non-key fields, program names, and environment names in the database environment, such as the SAP environment, and as such is not limited to the tables, key fields, non-key fields, program names, and environment names in the database environment used as examples.

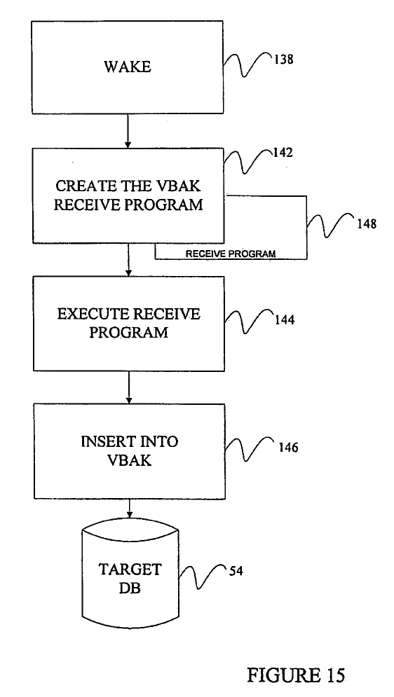

Refer now to FIG. 15, which shows methods of waking up the target 14 and inserting data from the flat file 136 into a specified database on the target 14. The target 14 is woken up in wake operation 138 and a program create generation 142 creates a database receive program 148 is created and transferred to the target 14. The database receive program 148 is executed in execution operation 144 on the target 14, which inserts the data in a data insert operation 146 that is in the flat file 136 into the target database 54, using an insert or update. The updating of the database is a well-known process for the SAP and for all database systems. Thus, the methods of the invention allow the refresh of all information and also avoid generating different document numbers, as would be the case with a client copy in SAP. The databases of the source 12 and target 14 are now one-to-one.

The select/refresh system 21 can easily be maintained, as new tables and fields are added to the source database 60, only those new cases need to be handled and could easily be run by a periodic background job. The background job would determine if there are any tables that are now populated and that weren't already existing and whether those tables would be linkable with the current data structures.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, all changes that come within the meaning and range of equivalency of the claims are intended to be embraced therein.

### COMPUTER PROGRAM LISTING APPENDIX

A computer program listing appendix was previously submitted on a compact disc concurrently with the filing of parent application Ser. No. 10/688,311, on Oct. 16, 2003, and the material of the compact disc is incorporated by reference hereto. The total number of compact discs is one with the number of files totaling 28.

The following files on CD Rom Copy 1 (submitted with the parent application) are incorporated by reference hereto and are collectively referred to as computer program listing appendix:

| | | | | |
|---|---|---|---|---|
| 10/16/2003 | 11:00 a | 1,302 | bytes | LZSEL_TARGET$01.txt |
| 10/16/2003 | 11:00 a | 42,353 | bytes | LZSEL_TARGETF01.txt |
| 10/16/2003 | 11:00 a | 1,009 | bytes | LZSEL_TARGETTOP.txt |
| 10/16/2003 | 11:00 a | 5,473 | bytes | LZSEL_TARGETU01.txt |
| 10/16/2003 | 11:00 a | 342 | bytes | LZSEL_TARGETUXX.txt |
| 10/16/2003 | 11:00 a | 747 | bytes | SAPLZSEL_TARGET.txt |
| 10/16/2003 | 11:05 a | 901 | bytes | ZSELIR_DOC_PROGRAMS.TXT |
| 10/16/2003 | 11:05 a | 1,693 | bytes | ZSELIR_LINK_DATA.TXT |
| 10/16/2003 | 10:58 a | 7,686 | bytes | ZSELI_CHECK_CONFIG_TABLES.TXT |
| 10/16/2003 | 10:58 a | 2,806 | bytes | ZSELI_EXCLUDED_TABLES.TXT |
| 10/16/2003 | 11:05 a | 842 | bytes | ZSELI_LINK_DATA.TXT |
| 10/16/2003 | 11:05 a | 2,474 | bytes | ZSELI_LINK_FILTER.TXT |
| 10/16/2003 | 11:05 a | 198,802 | bytes | ZSELI_LINK_FORMS.TXT |
| 10/16/2003 | 10:58 a | 37,155 | bytes | ZSELI_TABLES_FORMS.TXT |
| 10/16/2003 | 10:58 a | 1,016 | bytes | ZSELI_TABLES_MASTER.TXT |
| 10/16/2003 | 11:07 a | 7,745 | bytes | ZSELU_NRIV.TXT |
| 10/16/2003 | 11:06 a | 7,280 | bytes | ZSEL_ALL_DATA_DOCS.TXT |
| 10/16/2003 | 11:05 a | 1,231 | bytes | ZSEL_CHECK_ONR00.TXT |
| 10/16/2003 | 11:06 a | 504 | bytes | ZSEL_COMMON.TXT |
| 10/16/2003 | 11:06 a | 10,443 | bytes | ZSEL_COMMON_ALTERNATIVES.TXT |
| 10/16/2003 | 11:06 a | 33 | bytes | ZSEL_COMMON_DELETE.TXT |
| 10/16/2003 | 11:06 a | 238 | bytes | ZSEL_COMMON_HR.TXT |
| 10/16/2003 | 11:06 a | 210,720 | bytes | ZSEL_COMMON_LINK.TXT |
| 10/16/2003 | 11:06 a | 34,943 | bytes | ZSEL_COMMON_ONLINE.TXT |
| 10/16/2003 | 11:06 a | 22,890 | bytes | ZSEL_IN.TXT |
| 10/16/2003 | 11:06 a | 21,262 | bytes | ZSEL_MARA_REFRESH.TXT |
| 10/16/2003 | 11:05 a | 24,000 | bytes | ZSEL_OUT.TXT |
| 10/16/2003 | 11:06 a | 5,226 | bytes | ZSEL_SALES_REFRESH.TXT |
| 10/16/2003 | 11:06 a | 493 | bytes | ZSEL_COMMON_OPTIONS.TXT |
| 10/16/2003 | 11:06 a | 2,899 | bytes | ZSEL_COMMON_PROGRAM_VERSIONS.TXT |
| 10/16/2003 | 11:06 a | 109,525 | bytes | ZSEL_COMMON_SEND.TXT |
| 10/16/2003 | 11:06 a | 56,673 | bytes | ZSEL_COMMON_TOP.TXT |
| 10/16/2003 | 11:06 a | 6,607 | bytes | SEL_FI_DOCS.TXT |
| 10/16/2003 | 11:06 a | 42,292 | bytes | ZSEL_SALES_DOCS.TXT |
| 10/16/2003 | 11:06 a | 1,920 | bytes | ZSELA_KEKO_KEPH.TXT |
| 10/16/2003 | 11:06 a | 2,247 | bytes | ZSELA_VAKPA.TXT |

A second copy of CD Rom Copy 1, labeled Copy 2, was also submitted concurrently with the filing of the parent application and is identical to Copy 1.

What is claimed is:

1. A computerized method for extracting data of interest from a source and dynamically populating a target with the data of interest, said computerized method comprising:
a. providing a source database having a plurality of source tables containing data items, each source table including at least one key field;
b. providing a target database having a plurality of target tables and a structure which is similar to that of said source database;
c. providing a data dictionary which identifies relationships between said source tables and key fields therein;
d. receiving user-defined criteria corresponding to the data of interest that is to be selected in said source and refreshed in said target;
e. initiating a linking process which is operative to interrogate said data dictionary to identify, based on said user-defined criteria, relevant relationships between tables of interest within said source database and their associated said key fields, and group said tables of interest into at least one logical group; and
f. dynamically building and executing an associated program with respect to each said logical group, each said program operative to extract a corresponding sub-set of said data of interest from the source and thereafter load of said sub-set into the target, thereby populating the target database with the data of interest.

2. A computerized method according to claim 1 whereby said method is implemented in an enterprise resource planning (ERP) environment using an SAP database for said source and set target.

3. A computerized method according to 2 whereby said source is a production level database and said target is not a production level database.

4. A computerized method according to claim 1 which avoids transferring all or substantially all data items within said source database to the target database, thereby to reduce time in which the data of interest is extracted from the source and populated into the target.

5. A computerized method according to claim 1 whereby said tables of interest within the source database are grouped into a plurality of logical groups based on said user defined criteria, and whereby a plurality of programs are executed for creating dynamic programs, each of which is operative to send a respective one of said tables of interest to the target and load its associated subset of data of interest into the target.

6. A computerized method according to claim 1 whereby said target database initially contains only static data, in the form of configuration data built from the source.

7. A computerized method according to claim 1 wherein the tables of interest within the source database are grouped into a plurality of logical groups based on said user defined criteria, and wherein said linking process is further operative to check each table of interest against said data dictionary to identify both direct and indirect relationships among tables in the logical groups.

8. A select and refresh system, comprising:
a. a source database having a plurality of source tables containing data items, each source table including at least one key field;
b. a target database having a plurality of target tables and a structure similar to that of said source database;
c. a data dictionary which identifies relationships between said source tables and key fields therein;
d. a user interface for receiving user-defined criteria corresponding to data of interest that is to be extracted from said source database and copied to said target database; and
e. a linked database transfer system operative to:
(i) interrogate said data dictionary to identify, based on said user-defined criteria, relevant relationships between tables of interest within said source database and their associated key fields, and group said tables of interest into at least one logical group; and
(ii) dynamically execute an associated program with respect to each said logical group, each said program operative to extract a corresponding sub-set of said data of interest from the source and thereafter trigger creation of a dynamic program in the target to load said sub-set into the target, thereby to populate the target database with the data of interest.

9. A select and refresh system according to claim 8 wherein said source is a production level database and said target is not a production level database.

10. A computerized method for extracting data of interest from a source and dynamically populating a target with the data of interest, said computerized method comprising:
a. providing a source database having a plurality of source tables each containing data items;
b. providing a target database having a plurality of target tables and a structure which is similar to that of said source database;
c. providing a data dictionary which identifies relationships between said source tables and key fields therein;
d. receiving pre-defined criteria corresponding to the data of interest that is to be selected in said source and refreshed in said target;
e. identifying, based on the pre-defined criteria, a subset of tables from said source tables to be transferred to the target.
e. dynamically building and executing programs each of which is operative to transfer to the target all data within a respective one of said subset of tables, thereby populating the target database with the data of interest.

11. A computerized method according to claim 10 wherein said pre-defined criteria incorporates user-defined criteria.

12. A computerized method according to claim 10 wherein said target database initially contains only static data, in the form of configuration data built from the source.

13. A computerized method according to claim 10 wherein said target database has a structure which is identical to that of said source database.
